(19) United States
(12) Patent Application Publication
(10) Pub. No.: US 2007/0298207 A1
(43) Pub. Date: Dec. 27, 2007

(54) Single-sided, multilayered optical disc, BCA recording apparatus, BCA recording method, and optical disc apparatus

(76) Inventors: Keiichiro Yusu, Yokohama-shi (JP); Naomasa Nakamura, Yokohama-shi (JP); Nobuhisa Yoshida, Kamakura-shi (JP); Koji Takazawa, Tokyo (JP); Seiji Morita, Yokohama-shi (JP); Hideo Ando, Hino-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/820,339

(22) Filed: Jun. 19, 2007

(30) Foreign Application Priority Data
Jun. 21, 2006 (JP) 2006-171425

(51) Int. Cl. B32B 3/02

(52) U.S. Cl. 428/64.4

(57) ABSTRACT

According to one embodiment, a single-sided, multilayered optical disc which performs recording and playback when irradiated with a laser beam having a predetermined wavelength, and has at least two recording layers that are independent of each other with respect to the light incident surface, a reflecting layer farthest from the light incident surface contains an Ag alloy, and has a light absorbance of 20% (inclusive) to 50% (inclusive) to a laser beam and/or a thermal conductivity of 50 (inclusive) to 250 (inclusive) W/m·K.

### CROSS-REFERENCE TO RELATED APPLICATIONS

This application is based upon and claims the benefit of priority from Japanese Patent Application No. 2006-171425, filed Jun. 21, 2006, the entire contents of which are incorporated herein by reference.

### BACKGROUND

1. Field

One embodiment of the present invention relates to a single-sided, multilayered optical disc having two or more recording layers on one side. More particularly, the present invention relates to a single-sided, multilayered optical disc that records a disc management information in a layer farther from the light-receiving surface, a BCA recording apparatus for recording a disc management information and BCA recording method of recording BCA recording information in a BCA of this single-sided, multilayered optical disc, and an optical disc apparatus that records information on or plays back information from the single-sided, multilayered optical disc.

2. Description of the Related Art

Optical discs for high-density information recording/playback using light are roughly classified into read-only optical discs on which information is prerecorded when a user obtains them, and recordable optical discs on which a user records information.

The recordable optical discs include phase change optical discs that are rewritable any number of times, and write-once optical discs that can be recorded just once. On any of these optical discs, a disc management information area and main information recording area are formed in this order from the inner peripheral portion of the disc. Disc management information is recorded in the disc management information area, i.e., a so-called BCA (Burst Cutting Area).

The BCA of a read-only disc is preformed as a barcode mark on a stamper, so discs having the BCA in which the same information is recorded are mass-produced as long as the contents remain the same. For recordable optical discs, on the other hand, an initializing apparatus or the like forms disc management information unique to each disc in the BCA when shipping the disc from the factory.

To form the BCA in a second layer, which will be referred to as an L1 layer hereinafter, viewed from the light incident side of a write-once, single-sided, double-layered disc, a laser must be emitted through a first layer. However, this method is unsuitable as a BCA formation method not only because a high-power laser is necessary to compensate for absorption by the first layer to be referred to as an L0 layer hereinafter, but also because the laser has an effect on this L0 layer as well. Therefore, a method of forming the BCA by emitting a laser from the reflecting layer side of the L1 layer, i.e., from the label printed surface is performed. Each recording layer of a write-once, single-sided, double-layered disc has High-to-Low (H-to-L) polarity with which the reflectance lowers after recording, so the reflectance of a space portion is lowered by irradiating it with a laser.

A method of lowering the reflectance of a space portion is the same as that for a single-layered, write-once disc. However, a high power is required to destroy the reflecting layer by directly heating and melting it by emitting a laser from the reflecting layer side. This increases the load on the laser.

On the other hand, an HD-DVD presently being standardized as a next-generation DVD admits, as the write-once standards, a recording method that uses the reflectance polarity opposite to that of the conventional DVD, i.e., the characteristic by which the reflectance rises after recording. This characteristic will be referred to as Low-to-High or L-to-H hereinafter. Accordingly, the BCA is formed by the polarity opposite to that of the conventional method; the reflectance of a recording portion is raised by irradiating it with a laser. In addition, a write-once, single-sided, double-layered disc having the L-to-H polarity is currently being studied as a next-generation DVD. In this disc, similar to the double-layered discs now in use, the BCA is formed by emitting a laser from the reflecting layer side of the L1 layer. Also, the optical disc standards Blu-ray using a blue-violet laser having a wavelength of 405 nm and a numerical aperture (NA) of 0.85 presumably pose similar problems in regard to BCA formation on a write-once, single-sided, double-layered disc.

As described above, no BCA formation method has been established yet for a write-once, single-sided, double-layered optical disc.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a view for explaining recording layers of a single-sided, double-layered optical disc according to an embodiment of the present invention;

FIG. 2 is a sectional view for explaining the arrangement of the recording layers shown in FIG. 1;

FIG. 3 is a view showing the sectional structure of an embodiment of a write-once, single-sided, double-layered optical disc of the present invention;

FIG. 4A is a view for explaining examples of the contents of a BCA record recorded in a BCA;

FIG. 4B is a view for explaining examples of the contents of the BCA record recorded in the BCA;

FIG. 5 is a graph showing the relationship between the laser output for BCA formation and the reflectance in an example of the single-sided, double-layered optical disc;

FIG. 6 is a graph showing the relationship between the laser output for BCA formation and the reflectance in another example of the single-sided, double-layered optical disc;

FIG. 7 is a view for explaining an example of the arrangement of an apparatus for recording specific information in the BCA;

FIG. 8 is a flowchart showing a method of recording specific information in the BCA; and

FIG. 9 is a schematic view showing a recording/playback apparatus for recording information on or playing back information from the single-sided, double-layered optical disc.

### DETAILED DESCRIPTION

Various embodiments according to the invention will be described hereinafter with reference to the accompanying drawings. In general, according to one embodiment of the invention, a single-sided, multilayered optical disc comprises a transparent substrate, and two or more optical recording layers formed on the transparent substrate, configured to perform recording and playback when irradiated with a laser beam through the transparent substrate, and having an organic dye layer and a light reflecting layer sequentially stacked from a side of the transparent substrate, wherein a reflecting layer farthest from the transparent substrate contains a silver alloy, and has a light absorbance of 20% (inclusive) to 50% (inclusive) to a laser beam and/or a thermal conductivity of 50 (inclusive) to 250 (inclusive) W/m·K.

A burst cutting area recording method uses a single-sided, multilayered optical disc comprising a transparent substrate, and two or more optical recording layers formed on the transparent substrate, configured to perform recording and playback when irradiated with a laser beam through the transparent substrate, and having an organic dye layer and a light reflecting layer sequentially stacked from a side of the transparent substrate, wherein a reflecting layer farthest from the transparent substrate contains a silver alloy, and has a light absorbance of 20% (inclusive) to 50% (inclusive) to a laser beam and/or a thermal conductivity of 50 (inclusive) to 250 (inclusive) W/m·K, and records specific information concerning the single-sided, multilayered optical disc in a burst cutting area of the single-sided, multilayered optical disc by irradiating a reflecting layer farthest from the transparent substrate with a laser beam to change an organic dye layer farthest from the transparent substrate.

A burst cutting area recording apparatus of another aspect comprises a rotary driver which rotates a base for mounting a single-sided, multilayered optical disc comprising a transparent substrate, and two or more optical recording layers formed on the transparent substrate, configured to perform recording and playback when irradiated with a laser beam through the transparent substrate, and having an organic dye layer and a light reflecting layer sequentially stacked from a side of the transparent substrate, wherein a reflecting layer farthest from the transparent substrate contains an Ag alloy, and has a light absorbance of 20% (inclusive) to 50% (inclusive) to a laser beam and/or a thermal conductivity of 50 (inclusive) to 250 (inclusive) W/m·K, and a laser emitting mechanism which emits a laser beam to a reflecting layer farthest from the transparent substrate to change an organic dye layer farthest from the transparent substrate, on the basis of specific information to be recorded in a burst cutting area of the single-sided, multilayered optical disc.

A single-sided, multilayered optical disc of the present invention has a transparent substrate, and two or more optical recording layers formed on the transparent substrate. In this single-sided, multilayered optical disc, an emitted recording/playback laser beam enters from the transparent substrate and reaches the optical recording layers. The optical recording layers have an arrangement in which an organic dye layer and light reflecting layer are sequentially stacked from the transparent substrate side. A light reflecting layer farthest from the laser beam incident surface of the transparent substrate contains a silver alloy, and has a light absorbance of 20% (inclusive) to 50% (inclusive) to a laser beam and/or a thermal conductivity of 50 (inclusive) to 250 (inclusive) W/m·K.

In the present invention, the Ag alloy is used in the light reflecting layer farthest from the laser beam incident surface of the single-sided, multilayered optical disc. This facilitates BCA formation from the surface opposite to the laser beam incident surface by controlling the thermal conductivity and/or light absorbance.

To form a BCA on, e.g., a write-once, single-sided, double-layered disc, a high-output laser is emitted to a position of a predetermined radial position designated by the standards from the surface (to be referred to as the disc back surface hereinafter) opposite to the light incident surface of the disc rotated at a constant velocity, thereby heating the Ag-alloy reflecting layer of an L1 layer as the light reflecting layer farthest from the laser beam incident surface. The heat generated in the Ag-alloy reflecting layer is conducted to the organic dye layer to change the properties of the organic dye by the same principle as for recording to a main information recording area, thereby changing the reflectance.

Simultaneously, the Ag-alloy reflecting layer itself undergoes chemical changes such as oxidation and physical shape changes. This further increases the reflectance change. To efficiently form the BCA in the L1 layer without affecting the L0 layer as described above, the present invention sets the thermal conductivity and/or light absorbance in a predetermined range.

When the thermal conductivity of the Ag-alloy reflecting layer is 250 W/m·K or less, the heat is well conducted to the organic dye layer to change its reflectance. If the thermal conductivity is 250 W/m·K or more, the surface heat conduction of the Ag-alloy reflecting layer becomes significant to make heat conduction to the organic dye layer difficult.

On the other hand, if the thermal conductivity is less than 50 W/m·K, no heat is conducted to the organic dye layer, so the organic dye layer remains unchanged. This often makes it difficult to record data in the main information recording area, which is the original function of the write-once optical disc.

Furthermore, the light absorbance of the Ag-alloy reflecting layer also has an influence on BCA formation. When the light-absorbance of the Ag-alloy reflecting layer is 20% or more, a portion irradiated with a laser beam generates heat and efficiently absorbs the emitted laser beam. This facilitates heat conduction to the organic dye layer. If the light absorbance is less than 20%, the emitted light is not efficiently converted into heat, so a high-output laser is often necessary. However, as the light absorbance of the Ag-alloy reflecting layer becomes larger than 50%, the light reflectance becomes smaller than 50%. This may make it difficult to obtain a sufficient playback reflectance in the BCA of the L1 layer and in the main information recording area. When the light absorbance of the Ag-alloy reflecting layer is 20% or more, the BCA can be formed by a practical laser output.

For these reasons, an aspect of the present invention can achieve both BCA formation and the recording characteristics by an arrangement in which the reflecting layer farthest from the transparent substrate contains an Ag alloy, the light absorbance of the Ag alloy reflecting layer of the L1 layer having a light absorbance of 20% (inclusive) to 50% (inclusive) to a laser beam is 50% or less, and the thermal conductivity is 50 (inclusive) to 250 (inclusive) W/m·K.

The Ag alloy used in the present invention can contain Ag and at least one type of a metal selected from the group consisting of, e.g., Bi, Cu, Mg, Pd, Pt, Sn, Ti, and In.

The content of the metal can be 0.1 to 5 at % of the whole Ag alloy.

Also, an azo metal complex can be used as the organic dye material used in the organic dye layer of the present invention.

As the azo metal complex, it is possible to use, e.g., a compound represented by
C₅₇H₅₉CoN₁₂O₁₀ (1)

In addition to the compound represented by formula (1) above, it is also possible to uses e.g., C₃₈H₃₂N₁₄NiO₁₈, C₅₅H₆₁CoN₁₀O₈, C₅₇H₅₇CoN₁₂O₁₀.

As the transparent substrate, it is possible to use, e.g., polycarbonate (PC), polymethylmethacrylate (PMMA), Amorphouspolyolefine (APO).

A BCA is formed on the write-once optical disc according to the present invention by the following method. A radial position designated by the standards of a rotating disc is irradiated with laser pulses from the disc back surface by focusing the laser at the L1 layer. Since the properties of the Ag-alloy reflecting layer and organic dye layer in the pulse irradiated portion change, the reflectance becomes lower than that of an unirradiated portion, thereby forming a ring-like barcode BCA.

An embodiment of the present invention will be explained in detail below with reference to the accompanying drawing.

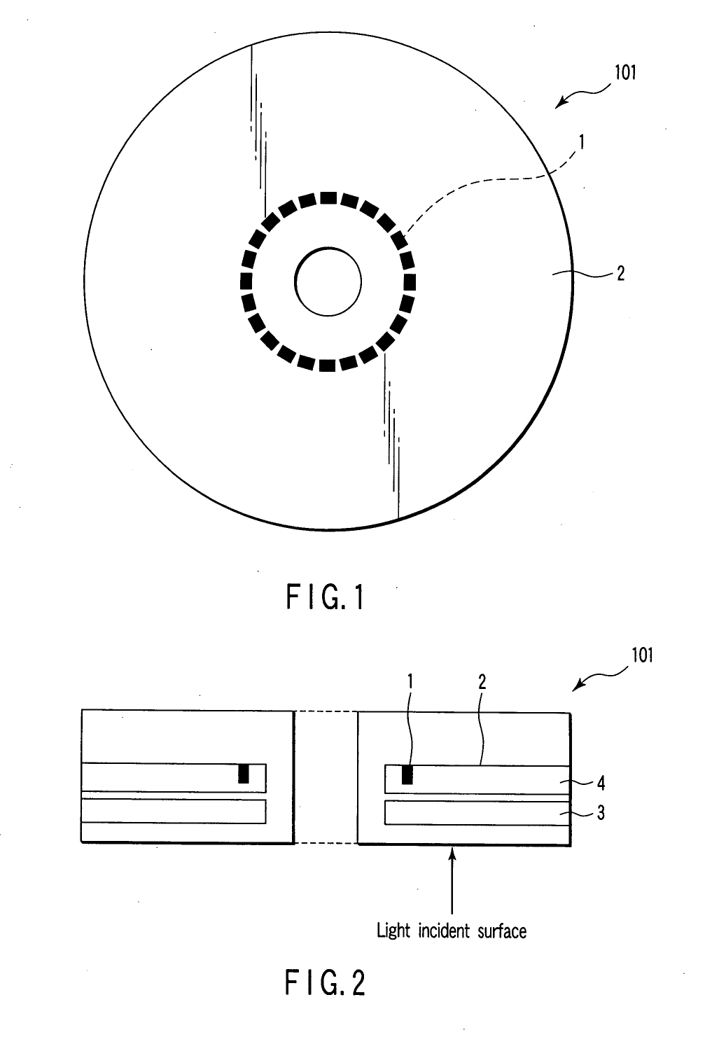

FIG. 1 is a front view for explaining recording layers of a write-once, single-sided, double-layered optical disc according to the embodiment of the present invention.

FIG. 2 is a sectional view for explaining the arrangement of the recording layers of the disc shown in FIG. 1.

A write-once, single-sided, double-layered optical disc 101 has an L0 recording layer 3 and L1 recording layer 4 formed in this order from the light incident surface side. The L1 recording layer 4 has a band 1 as a BCA in which disc management information is prewritten, and a main information recording area 2 as an area in which a user records data. When forming the BCA, a high-output laser is emitted to a radial position designated by the standards from the side (the disc back surface) opposite to the light incident side of the disc rotated at a constant velocity, thereby heating an Ag-alloy reflecting layer of the L1 layer 4.

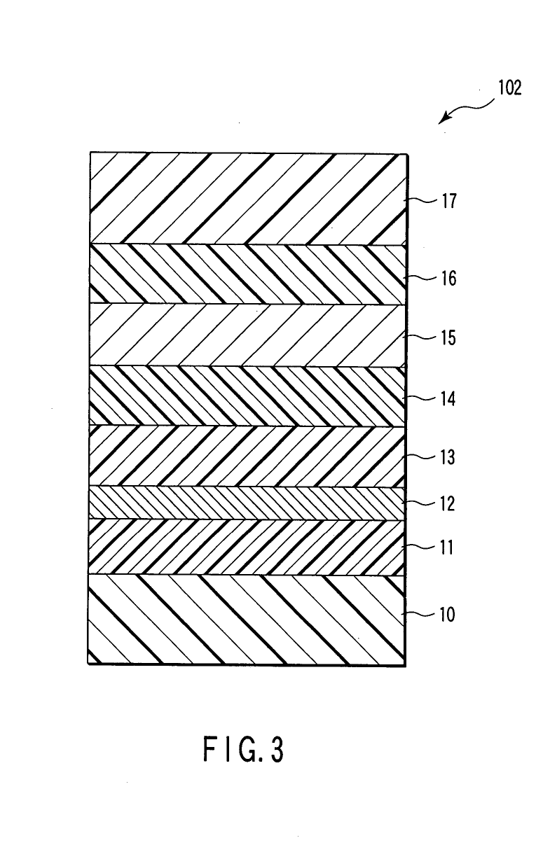

FIG. 3 is a view showing the sectional structure of an embodiment of the write-once, single-sided, double-layered optical disc of the present invention.

As shown in FIG. 3, an L0 layer including an organic dye layer 11 and transmitting reflecting layer 12 and an L1 layer including an organic dye layer 14 and total reflecting layer 15 are formed with an intermediate layer 13 made of ultraviolet-curing resin between them on a disc-like transparent substrate 10 made of, e.g., polycarbonate (PC) that transmits a light-source wavelength. In addition, polycarbonate 17 is adhered via an ultraviolet-curing resin layer 16.

The design of the optical disc according to the present invention can be appropriately changed in accordance with an optical system of a recording/playback apparatus.

For example, the thicknesses of the PC 10 and PC 17 can be selected in accordance with an objective lens NA of the recording/playback apparatus. When the recording/playback apparatus has a light-source wavelength of 405 nm and an objective lens NA of 0.65, for example, the thicknesses of both the PC 10 and PC 17 can be about 0.6 mm. When the light-source wavelength is 405 nm and the objective lens NA is 0.85, the thickness of the PC 10 can be about 0.1 mm, and that of the PC 17 can be about 1.1 mm. The effects of the present invention can be achieved by thus changing the design.

The write-once, single-sided, double-layered optical disc shown in FIG. 3 was formed as follows.

Formation of Disc A

An L0 layer was formed on a PC transparent substrate 10 having a diameter of 120 mm and a thickness of 0.6 mm, in which the physical structure of a main information recording area 2 was preformatted. This L0 layer included an organic dye layer 11 about 80 nm thick formed by coating the substrate 10 with a coating solution containing an azo metal complex and, e.g., 2,2,3,3-tetrafluoro-1-propanol (TFP) by using a spin coater, and a 17-nm thick reflecting layer 12 formed by sputtering Ag₉₈Pd₁Cu₁ by the RF magnetron sputtering process. Subsequently, an interlayer 13 made of ultraviolet-curing resin was formed by spin coating, and a PC stamper formatted for an L1 layer was pushed against the interlayer 13 to transfer the format. After that, the resin was cured by ultraviolet radiation. Then, an L1 layer was formed by forming an 80-nm thick organic dye layer 14 by coating in the same manner as for the L0 layer, and forming a 100-nm thick Ag₉₈Pd₁Cu₁ reflecting layer 15 in the same manner as for the L0 layer. In addition, a PC stamper 27 used to transfer the format of the L1 layer was adhered via an ultraviolet-curing resin layer 16, thereby forming disc A according to the present invention.

Formation of Disc B

Comparative disc B was formed following the same procedures as for disc A except that Ag was used instead of Ag₉₈Pd₁Cu₁ as a reflecting layer 15 of an L1 layer. Obtained disc B had the same arrangement as shown in FIG. 3 except for the material of the reflecting layer 15 of the L1 layer.

Formation of BCA on Discs A & B

A BCA was formed in a region from a radius of 22.3 mm to a radius of 23.15 mm of each completed disc by emitting a laser beam from the disc back surface under the conditions shown in Table 1 below.

TABLE 1
Laser beam emitting conditions

| | | |
|---|---|---|
| Wavelength | 650 | nm |
| Output | 500-2000 | mW |
| Beam diameter (radial direction) | 196 | μm |
| Beam diameter (track direction) | 1 | μm |
| Feed pitch (radial direction) | 196 | μm |

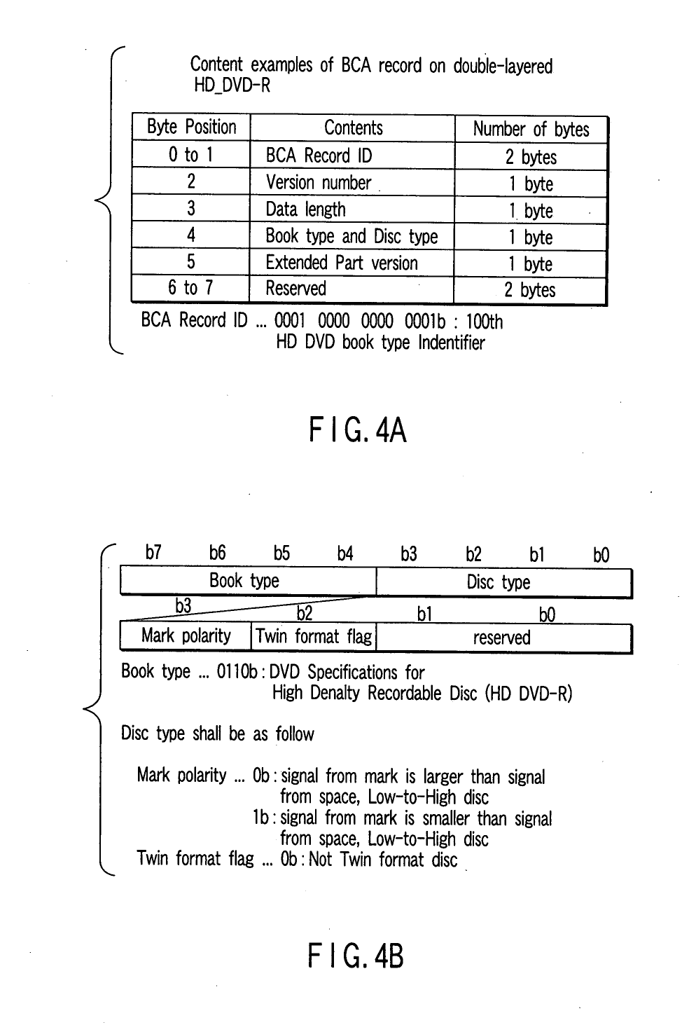

FIGS. 4A and 4B show an example of the physical structure of the BCA.

As shown in FIG. 4A, in a BCA record recorded in this BCA, relative byte positions 0 to 1 describe the BCA record ID (indicating an HD_DVD book type identifier), relative byte position 2 describes the version number of the applied standards, relative byte position 3 describes the data length, relative byte position 4 describes the book type and disc type of the standard document, relative byte position 5 describes the extended part version, and relative byte positions 6 to 7 are reserved to describe other information.

Of this BCA record, FIG. 4B shows examples of the fields of the book type and disc type of the standard document with which the disc complies. That is, information indicating that the disc complies with the standards for HD_DVD-R can be described in the book type field, and a mark polarity flag and twin format flag can be described in the disc type field.

When the mark polarity flag shown in FIG. 4B is “0b”, it can indicate that the disc is a “Low-to-High” disc in which a signal from a recording mark is larger than that from a space (between adjacent marks). When the mark polarity flag is “1b”, it can indicate that the disc is a “High-to-Low” disc in which a signal from a recording mark is smaller than that from a space. Also, when the twin format flag is “0b”, it can indicate that the disc is not a twin format disc; when the twin format flag is “1b”, it can indicate that the disc is a twin format disc. When the disc is a twin format disc, the disc (on which this BCA record is recorded) has two recording layers, and these two recording layers have different formats (e.g., HD_DVD-Video format and HD_DVD-Video Recording format) defined by the DVD forum.

There is no twin format disc among the existing DVDs, but a twin format disc can exist among next-generation HD_DVDs. Therefore, the ability to describe the twin format flag in the BCA has a significant meaning for the write-once, multilayered (double-layered) optical disc (next-generation HD_DVD disc) according to the embodiment of the present invention.

Measurements of BCA Playback Signal Characteristics of Discs A & B

The BCA playback signal characteristics of discs A and B were measured using the laser output as a parameter.

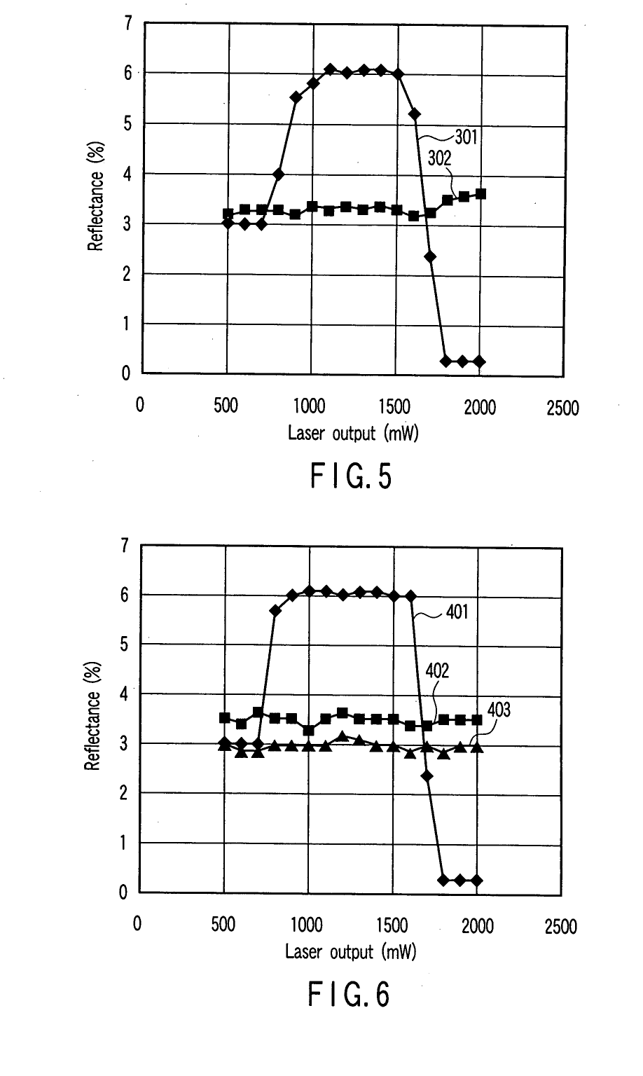

FIG. 5 shows the dependence of the reflectance of a laser irradiated portion upon the laser output.

Curves 301 and 302 respectively show the measurement results of discs A and B.

In disc A, the reflectance abruptly started increasing when the laser output was 800 mW, and was stable from 1,100 to 1,500 mW, indicating favorable recording characteristics. When the laser output was 1,600 mW or more, the excess heat destroyed the L1 Ag₉₈Pd₁Cu₁ reflecting layer to scatter the playback light, thereby abruptly decreasing the reflectance. If the disc can be used with a laser output of up to 1,600 mW, it is practically well possible to record data.

On the other hand, comparative disc B using Ag in the L1 reflecting layer remained unchanged with the measurement laser output.

The light absorbance of the L1 reflecting layer of disc A was 31%, and that of disc B was only 5%. Disc B using the 100-nm thick Ag reflecting layer having this small light absorbance did not effectively generate heat when irradiated with the laser. Since no heat was presumably conducted to the organic dye layer, the dye did not change.

The thermal conductivities of the L1 reflecting layers of discs A and B were respectively 220 W/m·K, 350 W/m·K. Therefore, heat was not conducted to the organic dye layer because heat was remarkably radiated in the reflacting layer.

Formation of Disc C

Disc C according to the present invention was formed following the same procedures as for disc A except that Ag₉₉Bi₁ was used instead of Ag₉₈Pd₁Cu₁. Obtained disc C had the same arrangement as shown in FIG. 3 except for the material of an L1 reflecting layer 15.

Formation of Comparative Discs D & E

Two types of comparative discs D and E were formed following the same procedures as for disc A except that Ag and Al were respectively used instead of Ag₉₈Pd₁Cu₁. Obtained discs D and E each had the same arrangement as shown in FIG. 3 except for the material of an L1 reflecting layer 15.

Formation of BCA on Discs C, D, & E

A BCA was formed in a region from a radius of 22.3 mm to a radius of 23.15 mm of each completed disc by emitting a laser beam from the disc back surface following the same procedures as for discs A and B described above.

Measurements of BCA Playback Signal Characteristics of Discs C, D, & E

The BCA playback signal characteristics of discs C, D, and E were measured using the laser output as a parameter following the same procedures as for discs A and B. FIG. 6 shows the dependence of the reflectance of a laser irradiated portion upon the laser output.

Referring to FIG. 6, curves 401, 402, and 403 respectively indicate discs C, D, and E.

In disc C according to the present invention, the reflectance rose when the output was 800 to 1,600 mW, indicating that data was well recorded in the L1 recording layer. However, the reflectance abruptly lowered when the output was 1,700 mW or more. This is so because the excess heat destroyed the L1 reflecting layer to scatter the playback light. However, it is practically well possible to record data with an output of up to 1,700 mW.

On the other hand, comparative discs D and E respectively using Ag and Al as the L1 reflecting layers remained unchanged with the measurement laser output. The thermal conductivities of a thin Ag₉₉Bi₁ film, thin Ag film, and thin Al film prepared at the same time were measured and found to be 180, 300, and 290 W/m·K, respectively. When Ag and Al having thermal conductivities higher than that of Ag₉₉Bi₁ were used in the reflecting layers, heat generated by laser irradiation mainly diffused in the longitudinal direction. Since no heat was probably conducted to the organic dye layers, the dyes did not change.

The light absorbance of the L1 reflecting layer was measuredst this time. The value of the light absorbance layer was 33% of Disc C, but a mere 4%, and 6% about Disc D, and E, respectively. It is considered that in Disc D and E with using a reflecting layer of 100 nm thick Al alloy having such smaller light absorbance, heat is not generated efficiently and therefore heat was conducted to the organic dye layer so that the dye could not be changed. Simaltaneously, heat conductivities of Ag₉₉Bi₁ thin film, AlTi thin film, AlMo thin film were measured. The values of the heat conductivities were 180 W/m·K, 150 W/m·K, 140 W/m·K, respectively. The values were not so large.

Discs C′, D′, and E′ were formed following the same procedures as for discs C, D, and E except that the thickness of a transparent substrate 10 as the light incident surface was changed to 0.1 mm, and the thickness of a substrate 17 was changed to 1.1 mm. When a BCA was formed from the disc back surface of each disc following the same procedures as above, similar results were obtained.

As described above, the present invention was effective in the formation of a BCA on a single-sided, double-layered optical disc regardless of the incident substrate thickness.

FIG. 7 is a view for explaining an example of the arrangement of an apparatus that records specific information including the BCA record shown in FIGS. 4A and 4B and the like in the BCA.

This apparatus comprises a spindle motor 206, spindle driver 204, laser beam emitter 210, laser output controller 208, and controller 202. The spindle motor 206 rotates a base for mounting a single-sided, multilayered optical disc 100. The single-sided, multilayered optical disc 100 has a transparent substrate, and two or more optical recording layers formed on the transparent substrate, capable of recording and playback when irradiated with a laser beam through the transparent substrate, and having an organic dye layer and light reflecting layer sequentially stacked from the transparent substrate side. A reflecting layer farthest from the transparent substrate contains an Ag alloy, and has a light absorbance of 20% (inclusive) to 50% (inclusive) to a laser beam and/or a thermal conductivity of 50 (inclusive) to 250 (inclusive) W/m·K. The spindle driver 204 drives the rotation of the spindle motor 206. The laser beam emitter 210 emits a laser beam to a BCA in an organic dye layer farthest from the transparent substrate into which a recoding/playback laser beam enters, through the reflecting layer farthest from the transparent substrate. The laser output controller 208 controls the laser output of the laser beam emitter 210. The controller 202 controls the laser output controller 208 on the basis of specific information to be recorded in the BCA of the single-sided, multilayered optical disc 100, and controls the spindle driver 204 in accordance with the laser output control.

The BCA recording apparatus records a BCA signal (a signal containing information such as the BCA record shown in FIGS. 4A and 4B) on the disc 100 as a finished product. The laser 210 is modulated in accordance with the BCA signal from the controller 202, and a barcode BCA mark is recorded in synchronism with the rotation of the disc 100. The laser wavelength of the BCA recording apparatus is selected from the range of 600 to 800 nm (generally, 650 to 780 nm or 680 to 780 nm).

In a double-layered optical disc, the BCA recording position is generally a region from a radius of 22.3 mm to a radius of 22.15 mm in the inner periphery of the L1 layer. When recording the BCA, the L1 layer is irradiated with a laser from the disc back surface. The embodiment of the present invention uses the Ag-alloy reflecting layer in the L1 layer to make the light absorbance of this reflecting layer be 20% (inclusive) to 50% (inclusive) to the light-source wavelength and/or the thermal conductivity of the reflecting layer be 50 (inclusive) to 250 (inclusive) W/m·K. Consequently, the BCA signal can be accurately selectively recorded in only the L1 layer.

By thus adjusting the sensitivity (the absorbance to the wavelength used) of the dye in each layer, the BCA signal can be recorded on a next-generation optical disc without changing the laser wavelength and laser power of the BCA recording apparatus generally used on the existing DVD manufacturing line. In addition, since the BCA signal can be selectively recorded in only the L1 layer, the L0 layer produces no extra crosstalk noise during playback.

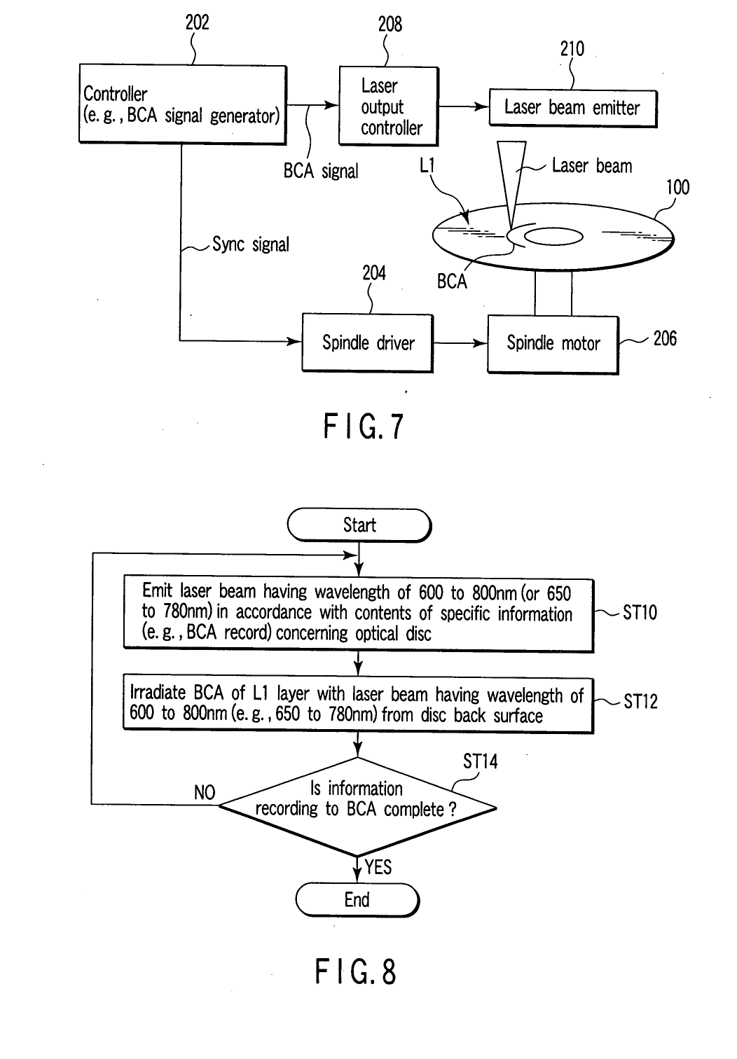

FIG. 8 is a flowchart for explaining an example of the procedure (BCA post cutting) of recording specific information in the L1 layer of the write-once, single-sided, multilayered (double-layered) optical disc.

When the BCA signal containing specific information such as the BCA record shown in FIGS. 4A and 4B is supplied from the controller 202 to the laser output controller 208 shown in FIG. 7, the laser diode 210 emits a laser beam having a wavelength selected from a wavelength of 600 to 800 nm (or 650 to 780 nm, or 680 to 780 nm) (ST10). The laser beam pulses thus emitted irradiate the BCA recording portion in the L1 layer from the back surface of the disc 100 (ST12). This irradiation continues in synchronism with the rotation of the disc 100. If there is no-more information to be recorded in the BCA (Yes in ST14), BCA post cutting from the disc back surface to the L1 layer is complete.

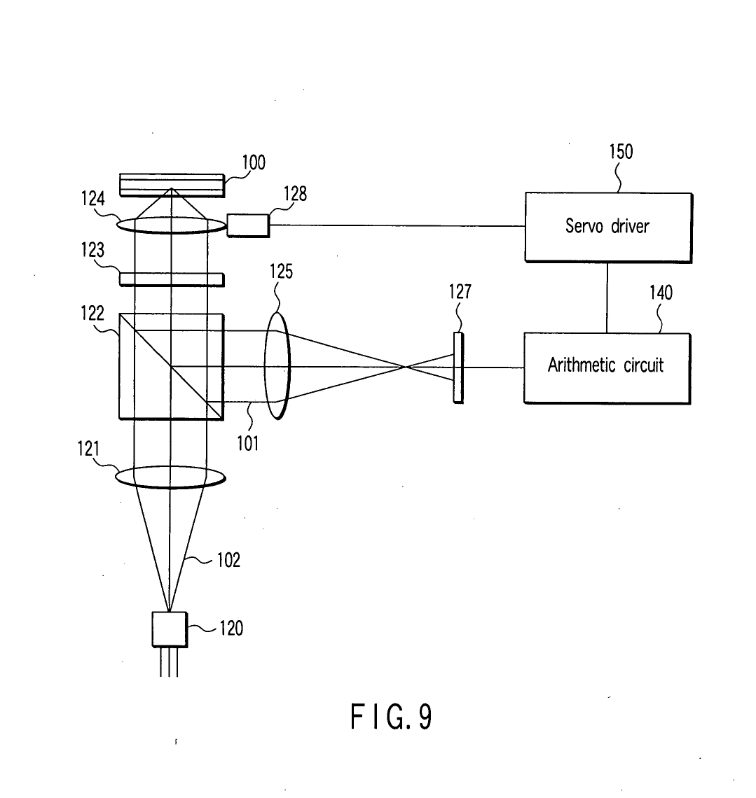

A recording/playback apparatus for recording information in or playing back information from the one-sided, double-layered optical disc of the present invention will be explained below with reference to FIG. 9.

As shown in FIG. 9, an optical disc 100 is the single-sided, double-layered optical disc of the present invention. A short-wavelength semiconductor laser light source 120 is used as the light source. The wavelength of the exit light is, e.g., the violet wavelength band within the range of 400 to 410 nm. A collimator lens 121 collimates exit light 102 from the semiconductor laser light source 120 into parallel light, and this parallel light enters an objective lens 124 through a polarizing beam splitter 122 and λ/4 plate 123. After that, the light is transmitted through the substrate of the optical disc 100, and concentrated to each information recording layer. Reflected light 101 from the information recording layer of the optical disc 100 is transmitted through the substrate of the optical disc 100, the objective lens 124, and the λ/4 plate 123 again. The polarizing beam splitter 122 then reflects the reflected light 101 to a photodetector 126 through a condenser lens 125.

A light-receiving portion of the photodetector 127 is normally divided into a plurality of portions, and each light-receiving portion outputs an electric current corresponding to the light intensity. An I/V amplifier (current-to-voltage converter) (not shown) converts the output electric current into a voltage, and applies the voltage to an arithmetic circuit 140. The arithmetic circuit 140 arithmetically processes the input voltage signal into a tilt error signal, HF signal, focusing error signal, tracking error signal, and the like. The tilt error signal is used to control a tilt. The HF signal is used to playback information recorded on the optical disc. The focusing error signal is used to control focusing. The tracking error signal is used to control tracking.

An actuator 128 can drive the objective lens 124 in the vertical direction, the disc radial direction, and the tilt direction (the radial direction and/or tangential direction). A servo driver 150 controls the actuator 128 to trace information tracks on the optical disc 100. Note that there are two types of tilt directions: “a radial tilt” that occurs when the disc surface inclines toward the center of the optical disc, and “a tangential tilt” that occurs in the tangential direction of a track. The warpage of a disc generally produces a radial tilt. It is necessary to take into account not only a tilt that occurs in the manufacture of a disc but also a tilt that occurs due to deterioration with age or a rapid change in the use environment. The single-sided, double-layered optical disc of the present invention can be played back by using the recording/playback apparatus as described above.

Note that the present invention is not limited to the above embodiments but can be variously modified when practiced without departing from the spirit and scope of the invention. Note also that the embodiments may also be practiced as they are appropriately combined as much as possible. In this case, the combined effects are obtained. Furthermore, the above embodiments include inventions in various stages, so various inventions can be extracted by properly combining a plurality of disclosed constituent elements. For example, even when some constituent elements are deleted from all the constituent elements disclosed in the embodiments, an arrangement from which these constituent elements are deleted can be extracted as an invention, provided that the problems described in the section of the problems to be solved by the invention can be solved, and that the effects described in the section of the effects of the invention are obtained.

What is claimed is:

1. A single-sided, multilayered optical disc comprising:
a transparent substrate; and
not less than two optical recording layers formed on the transparent substrate, configured to perform recording and playback when irradiated with a laser beam through the transparent substrate, and having an organic dye layer and a light reflecting layer sequentially stacked from a side of the transparent substrate,
wherein a reflecting layer farthest from the transparent substrate contains a silver alloy, and has a light absorbance of 20% (inclusive) to 50% (inclusive) to a laser beam.

2. A disc according to claim 1, wherein the silver alloy contains silver and at least one type of a metal selected from the group consisting of bismuth, copper, magnesium, palladium, platinum, tin, titanium, and indium.

3. A disc according to claim 1, wherein the laser beam has a wavelength of 400 to 830 nm.

4. A disc according to claim 1, wherein an organic dye material used in the organic dye layer is an azo metal complex.

5. A single-sided, multilayered optical disc comprising:
a transparent substrate; and
not less than two optical recording layers formed on the transparent substrate, configured to perform recording and playback when irradiated with a laser beam through the transparent substrate, and having an organic dye layer and a light reflecting layer sequentially stacked from a side of the transparent substrate,
wherein a reflecting layer farthest from the transparent substrate contains an Ag alloy, and has a thermal conductivity of 50 (inclusive) to 250 (inclusive) W/m·K.

6. A disc according to claim 5, wherein the silver alloy contains silver and at least one type of a metal selected from the group consisting of bismuth, copper, magnesium, palladium, platinum, tin, titanium, and indium.

7. A disc according to claim 5, wherein the laser beam has a wavelength of 400 to 830 nm.

8. A disc according to claim 5, wherein the silver alloy has a light absorbance of 20% (inclusive) to 50% (inclusive) to the wavelength.

9. A disc according to claim 5, wherein an organic dye material used in the organic dye layer is an azo metal complex.

10. A burst cutting area recording method which uses a single-sided, multilayered optical disc comprising a transparent substrate, and not less than two optical recording layers formed on the transparent substrate, configured to perform recording and playback when irradiated with a laser beam through the transparent substrate, and having an organic dye layer and a light reflecting layer sequentially stacked from a side of the transparent substrate, wherein a reflecting layer farthest from the transparent substrate contains a silver alloy, and has a light absorbance of 20% (inclusive) to 50% (inclusive) to a laser beam, and records specific information concerning the single-sided, multilayered optical disc in a burst cutting area of the single-sided, multilayered optical disc by irradiating a reflecting layer farthest from the transparent substrate with a laser beam to change an organic dye layer farthest from the transparent substrate.

11. A burst cutting area recording method which uses a single-sided, multilayered optical disc comprising a transparent substrate, and not less than two optical recording layers formed on the transparent substrate, configured to perform recording and playback when irradiated with a laser beam through the transparent substrate, and having an organic dye layer and a light reflecting layer sequentially stacked from a side of the transparent substrate, wherein a reflecting layer farthest from the transparent substrate contains an Ag alloy, and has a thermal conductivity of 50 (inclusive) to 250 (inclusive) W/m·K, and records specific information concerning the single-sided, multilayered optical disc in a burst cutting area of the single-sided, multilayered optical disc by irradiating a reflecting layer farthest from the transparent substrate with a laser beam to change an organic dye layer farthest from the transparent substrate.

12. A burst cutting area recording apparatus comprising:
a rotary driver which rotates a base for mounting a single-sided, multilayered optical disc comprising a transparent substrate, and not less than two optical recording layers formed on the transparent substrate, configured to perform recording and playback when irradiated with a laser beam through the transparent substrate, and having an organic dye layer and a light reflecting layer sequentially stacked from a side of the transparent substrate, wherein a reflecting layer farthest from the transparent substrate contains an Ag alloy, and has a light absorbance of 20% (inclusive) to 50% (inclusive) to a laser beam; and
a laser emitting mechanism which emits a laser beam to a reflecting layer farthest from the transparent substrate to change an organic dye layer farthest from the transparent substrate, on the basis of specific information to be recorded in a burst cutting area of the single-sided, multilayered optical disc.

13. A burst cutting area recording apparatus for recording a burst cutting area of a single-sided, multilayered optical disc comprising a transparent substrate, and not less than two optical recording layers formed on the transparent substrate, configured to perform recording and playback when irradiated with a laser beam through the transparent substrate, and having an organic dye layer and a light reflecting layer sequentially stacked from a side of the transparent substrate, wherein a reflecting layer farthest from the transparent substrate contains an Ag alloy, and has a thermal conductivity of 50 (inclusive) to 250 (inclusive) W/m·K, comprising:
a rotary driver which rotates a base for mounting the single-sided, multilayered optical disc; and
a laser emitting mechanism which emits a laser beam to a reflecting layer farthest from the transparent substrate to change an organic dye layer farthest from the transparent substrate, on the basis of specific information to be recorded in the burst cutting area of the single-sided, multilayered optical disc.

14. An optical disc apparatus as a recording apparatus for recording a burst cutting area of a single-sided, multilayered optical disc comprising a transparent substrate, and not less than two optical recording layers formed on the transparent substrate, configured to perform recording and playback when irradiated with a laser beam through the transparent substrate, and having an organic dye layer and a light reflecting layer sequentially stacked from a side of the transparent substrate, wherein a reflecting layer farthest from the transparent substrate contains an Ag alloy, and has a light absorbance of 20% (inclusive) to 50% (inclusive) to a laser beam, comprising:
a rotary driver which rotates a base mounting the single-sided, multilayered optical disc;
a laser beam emitter which emits a laser beam to the recording layer of the single-sided, multilayered optical disc from the side of the transparent substrate;
a laser beam receiver which receives reflected light of the laser beam reflected by the recording layer; and
playback means for playing back the single-sided, multilayered optical disc on the basis of the reflected light received by the laser beam receiver.

15. An optical disc apparatus as a recording apparatus for recording a burst cutting area of a single-sided, multilayered optical disc comprising a transparent substrate, and not less than two optical recording layers formed on the transparent substrate, configured to perform recording and playback when irradiated with a laser beam through the transparent substrate, and having an organic dye layer and a light reflecting layer sequentially stacked from a side of the transparent substrate, wherein a reflecting layer farthest from the transparent substrate contains an Ag alloy, and has a thermal conductivity of 50 (inclusive) to 250 (inclusive) W/m·K, comprising:
a rotary driver which rotates a base mounting the single-sided, multilayered optical disc;
a laser beam emitter which emits a laser beam to the recording layer of the single-sided, multilayered optical disc from the side of the transparent substrate;
a laser beam receiver which receives reflected light of the laser beam reflected by the recording layer; and
playback means for playing back the single-sided, multilayered optical disc on the basis of the reflected light received by the laser beam receiver.
